(19) United States
(12) Patent Application Publication
(10) Pub. No.: US 2009/0106109 A1
(43) Pub. Date: Apr. 23, 2009

(54) BUSINESS TO MEDIA TRANSACTION STANDARD

(75) Inventors: Jacek Waksmundzki, Warsaw (PL); Pawel Demczuk, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,344

(22) Filed: Oct. 21, 2008

Related U.S. Application Data
(60) Provisional application No. 60/981,722, filed on Oct. 22, 2007.

(51) Int. Cl. G06Q 30/00

(52) U.S. Cl. 705/14; 705/26

(57) ABSTRACT

A business to media (B2M) transaction standard provides for the visualization of, and transactions of wares, simultaneously, in real time, and over multiple analog and digital media in multiple analog and digital marketplaces. The B2M transaction standard describes a business environment which may involve four roles (buyers/clients, marketplace suppliers, the universal agent supplier and offer providers) and three component types (media, marketplaces and a universal agent). In accordance with the B2M transaction standard, one embodiment of a method for facilitating transactions of wares between customers and offer providers includes: (a) conducting an offer construction process involving one or more offer providers offering wares available for transaction with customers and the universal agent supplier providing the universal agent to which offers of wares are communicated; (b) conducting a marketplace construction process involving one or more marketplace suppliers providing one or more marketplaces and one or more media for customer communication with the marketplaces, wherein wares available on said marketplaces are provided by the universal agent; and (c) conducting a transaction process wherein the single universal agent operating separately from the one or more marketplaces processes transaction requests from customers relating to wares offered by the one or more offer providers on the one or more marketplaces and presented to the customers through the one or more media.

### RELATED APPLICATION INFORMATION

This application claims priority from U.S. Provisional Patent Application Ser. No. 60/981,722 entitled “BUSINESS TO MEDIA TRANSACTION STANDARD” filed on Oct. 22, 2007, which is incorporated by reference herein in its entirety.

### FIELD OF THE INVENTION

The present invention relates generally to standards for conducting transactions between parties, and more particularly to a standard by which transactions of goods and services in any business domain may be conducted using multiple analog and digital media.

### BACKGROUND OF THE INVENTION

A number of standards exist for conducting transactions between parties in communication network enabled environments. Generally, such existing standards for market segments deal with only one single marketplace, and usually only one media, and the interactions between the roles of the components and actors are not completely separated. Differentiated examples of each follow:
a. B2B (Business to Business)—a definition of relations between companies. This expression includes: preparation of offers, preparation of orders, order confirmation, payments, transaction completion, drawing up documents connected with transaction completion, and marketing. The implementation of this standard defines the agent as being undifferentiated from either the single marketplace (in this case, the offer provider fully delegates to the single marketplace/agent) or the offer provider (in this case, the offer provider retains confirmation control of the transaction). In most B2B solutions, there is also a single media (the Internet).
b. B2C (Business to Customer)—a definition of relations between one company and an end user, frequently connected by means of the Internet. The implementation of this standard defines the agent as being undifferentiated from the single marketplace and the offer provider (the offer provider provides the marketplace and acts as his own agent in any transactions).
c. C2B (Customer to Business)—e-business segment using the possibilities provided by Internet in order to reverse the traditional channel interactions between the multiple companies and the buyers/clients. The implementation of this standard defines the agent as being undifferentiated from the single marketplace (in one case) or undifferentiated from each offer provider (in the other case).
d. C2C (Consumer to Consumer)—the definition of Internet zones of business activity in the field of commerce and market oriented economy as seen by the private users. The Internet auctions may serve as an example of this type interaction. The implementation of this standard defines the agent as being undifferentiated from the single marketplace.
e. B2E (Business to Employee)—company “window displays” free information/services for access by all employees of the company. The implementation of this standard defines the agent as being undifferentiated from the single marketplace.

### SUMMARY OF THE INVENTION

The present invention provides a standard referred to herein as the business to media (B2M) transaction standard. The B2M transaction standard provides for the visualization of, and transactions of wares, simultaneously, in real time, and over multiple analog and digital media in multiple analog and digital marketplaces. In general, a “ware” is any good or service that an individual or an entity may reserve, schedule, order, buy, purchase, sell, deliver, provide, receive, rent, lease, or the like from/to another. The terms “ware” and “good/service” may be used interchangeably herein. In general, a “customer” is any individual or entity that may reserve, schedule, order, buy, purchase, receive, rent, lease, or the like a good or service. The terms “customer” and “buyer/client” may be used interchangeably herein. Further, a “transaction” refers to any activity involving a good or service including reserving, scheduling, ordering, buying, purchasing, selling, delivering, providing, receiving, renting, leasing, or the like of a good or service.

The B2M transaction standard describes a business environment which may involve four roles and three component types. The four roles are buyers/clients, marketplace suppliers, the universal agent supplier and offer providers. The three component types are media, marketplaces and the universal agent.

Various aspects and advantages of the B2M transaction standard include separation of the multiple media from the marketplaces, separation of the marketplaces from the single universal agent, the separation of the buyers/clients from the universal agent supplier, separation of marketplace suppliers from the universal agent supplier, separation of the offer providers from the universal agent supplier, a delegation by the offer providers to the single universal agent, the connection/representation of the offer providers to multiple marketplaces and the buyer/client access to multiple marketplaces through multiple media. In this regard, the B2M transaction standard involves logical separation of each actor and each component from the other actors and components. Such separation provides universality of transaction systems and processes configured in accordance with the B2M transaction standard.

The B2M transaction standard describes the relationship between various roles within all commonly recognized market segments (B2B, B2C, C2B, C2C, B2E). The B2M transaction standard is a description of a business environment where the transactions involving many goods/services and many buyers/clients and offer providers (or more generally buying, reservations and renting transactions) are served through one universal agent involving many marketplaces through multiple media.

The B2M transaction standard provides for multiple media access to many different marketplaces to be able to execute transactions for goods/services of many offer providers through a single universal agent. The offer provider may, by registering with the universal agent with delegation to the universal agent, be represented on multiple marketplaces accessed by multiple media.

The commonly used market standards (B2B, B2C, C2B, C2C, B2E) refer to the specified environment and in a sense they are dealing with one single media, one single marketplace, and the interaction between the roles of the media, the marketplace, the universal agent, the buyer/client and the offer provider is not completely separated. In contrast, the B2M transaction standard clearly separates these roles and delegates a transaction closure to the universal agent. This clear role separation and delegation makes possible multiple media and multiple marketplaces for buyers/clients and offer providers while offering the same terms and conditions from each buyer/client and offer provider. The advantage to the buyer/client and offer provider is that no matter what media that the buyer/client chooses to use, the terms of transactions are guaranteed to be the same.

In accordance with one aspect, a method for facilitating transactions of wares between customers and offer providers is provided consistent with the B2M transaction standard. Such a method comprises the steps of: (1) conducting an offer construction process; (2) conducting a marketplace construction process; and (3) conducting a transaction process. The offer construction process involves one or more offer providers and a universal agent supplier. In the offer construction process, the one or more offer providers offer wares available for transaction with customers, and the universal agent supplier provides a universal agent to which offers of wares are communicated. The marketplace construction process involves one or more marketplace suppliers and the universal agent supplier. In the marketplace construction process, the one or more marketplace suppliers provide one or more marketplaces and one or more media for customer communication with the marketplaces, and wares available on the marketplaces are provided by the universal agent. In the transaction process, a single universal agent operating separately from the one or more marketplaces processes transaction requests from customers relating to wares offered by the one or more offer providers on the one or more marketplaces and presented to the customers through the one or more media.

These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing a business environment with four groups of actors and three component types provided in accordance with the B2M transaction standard; and

FIG. 2 is a block diagram showing a business environment in accordance with the B2M transaction standard wherein the marketplaces and universal agent are implemented in an analog form.

### DETAILED DESCRIPTION

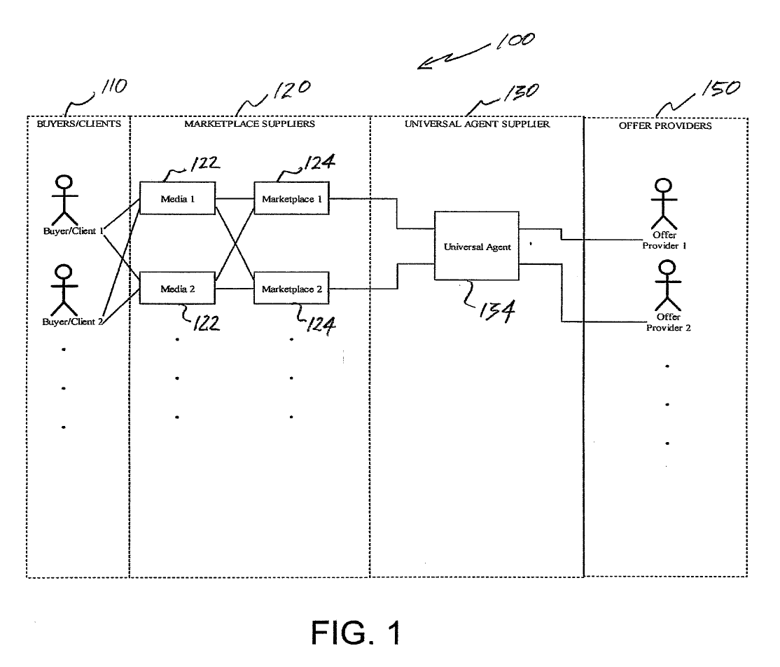

As shown in FIG. 1, the B2M transaction standard specifies a model 100 that includes four (4) groups of actors and three (3) component types. The four groups of actors interacting in this model are: buyers/clients 110, marketplace suppliers 120, the universal agent supplier 130 and offer providers 150. Three component types used in the model are: media 122, marketplaces 124 and the universal agent 134. In accordance with the B2M transaction standard, the various actors and components undertake various roles and/or have various interactions. The marketplaces 124 may be implemented in any analog and/or digital forms where goods/services are available through any media 122 to the buyers/clients 110, including, for example, in one embodiment as computer network enabled computer systems. The universal agent 134 may be implemented in any analog and/or digital form capable of processing all kinds of transactions (e.g. buying, selling, renting, reserving, scheduling, etc.) of all kinds of goods/services, including, for example, in one embodiment as a computer network enabled computer system. The universal agent 134 has the capability to complete transactions from multiple marketplaces 124.

### Roles

The role of the buyers/clients 110 is to request transactions (e.g., buy/reserve/schedule) of wares (goods/services) available on multiple marketplaces 124 through multiple media 122. There may be one, two or more buyers/clients 110.

The role of marketplace suppliers 120 is to provide marketplaces 124 in any area of perceived market need (e.g. computer shops, car shops, hair-dressers, ski rentals, hotels, etc.) in forms suitable to the buyers/clients 110. There may be one or more marketplace suppliers 120. The marketplaces 124 may be implemented in analog (e.g. shops, stands at the fairs, agencies, etc.) and/or digital (e.g. WWW sites, DTV programs, mobile portals, etc.) forms. Marketplace suppliers 120 also provide media 122 for communication by buyers/clients 110 with marketplaces 124. Media 122 include analog (e.g. analog phone, printed materials, etc.) and/or digital (e.g. Internet, mobile phones, digital TV, etc.) types.

The role of marketplaces 124 is to offer goods/services available from the universal agent 134 to the buyers/clients 110 and to mediate in transactions of those goods/services between the universal agent 134 and the buyers/clients 110. One, two or more marketplaces 124 may be provided by the marketplace suppliers 120.

The role of the media 122 is to enable one-way (e.g. billboards, newspapers, etc.) and two-way (e.g. Internet, mobile phones, etc.) communication between buyers/clients 110 and marketplaces 124. One, two or more media 122 may be provided by the marketplace suppliers 120.

The role of the universal agent supplier 130 is to provide the universal agent 134 in any needed form, including analog (e.g. one man, organization, etc.) and/or digital (e.g. computer system). The universal agent 134 is responsible for exchanging information between offer providers 150 and marketplaces 124 in both directions and is responsible for handling transactions on behalf of the offer providers 150, if offer providers 150 decide to delegate transaction handling to the universal agent 134.

The role of the universal agent 134 is to pass a goods/service offer from the offer providers 150 to the marketplaces 124 and inform offer providers 150 about transaction requests from the marketplaces 124.

The role of offer providers 150 is to have an offer of goods/services, to give an access to those goods/services to the universal agent 134 and to handle transactions incoming from universal agent 134 or (optionally) fully delegate transactions to the universal agent 134. There may be one, two or more offer providers 150.

### Interactions

The B2M transaction standard provides a business environment where three main interactions (Service offer construction, Marketplace construction, and Transaction process), which are described below, take place:

Service Offer Construction

The offer provider 150 defines goods/services, which will be available for transactions and describes those goods/services by naming their features such as: price, needed resources, place, etc. The offer provider 150 creates delegations by deciding which goods/services transactions the offer provider 150 will handle and which will be handled by the universal agent 134. The offer provider 150 adapts communication methods, provided by the universal agent supplier 130 for two-way communication between the offer provider 150 and the universal agent 134. When communication channels are established, the offer provider 150 places his offer and his delegations with the universal agent 134. The offer provider 150 does not have to be connected permanently to the universal agent 134, but in the case that offer provider 150 is not connected permanently to the universal agent 134, the goods/services without delegations may not be available to the buyers/clients 110. Goods/services without delegations may be available only when the offer provider 150 is connected to the universal agent 134.

Marketplace Construction

The marketplace supplier 120 establishes communication methods with the universal agent 134 and receives information about business domains available to the universal agent 134. The marketplace supplier 120 chooses at least one business domain and makes goods/services from this domain available to the buyers/clients 110 through at least one media 122. The marketplace 124 may stay permanently connected with universal agent 134 and presents to the buyers/clients 110 up to date offers with available goods/services only.

Transaction Process

The buyer/client 110 gets the information about the offers available on a marketplace 124 through a chosen media 122 that enables marketplace 124 to buyer/client 110 communication. If the chosen media 122 also supports a return communication channel, the buyer/client 110 uses it for making a transaction of a chosen good/service. When the chosen media 122 don't have a return channel, the buyer/client 110 uses other available media 122 with return communication capabilities to make this transaction. As the marketplace 124 stays connected to the universal agent 134, the transaction request is transmitted immediately from the marketplace 124 to the universal agent 134. If the universal agent 134 has been given delegation for the chosen goods/services, it accepts or refuses the transaction. If the universal agent 134 has not been given delegation for the chosen goods/services, the universal agent 134 informs the offer provider 150 about the transaction request and the offer provider 150 decides whether to accept it or refuse it. When the transaction status is set, the universal agent 134 informs the marketplace 124 about this status and the marketplace 124 makes this information available to the buyer/client 110.

In one embodiment, the B2M Transaction Standard takes form of a computer network based universal transaction system (CNBUTS). An example of a CNBUTS is more specifically described in a separate United States patent application filed contemporaneously herewith entitled “UNIVERSAL BUSINESS TO MEDIA TRANSACTION SYSTEM” (which application claims priority from U.S. Provisional Application No. 60/981,710 filed Oct. 22, 2007), the entire disclosure of which is incorporated by reference herein. It is an example of a B2M transaction standard business environment where the marketplace 124 and the universal agent 134 are implemented in digital form.

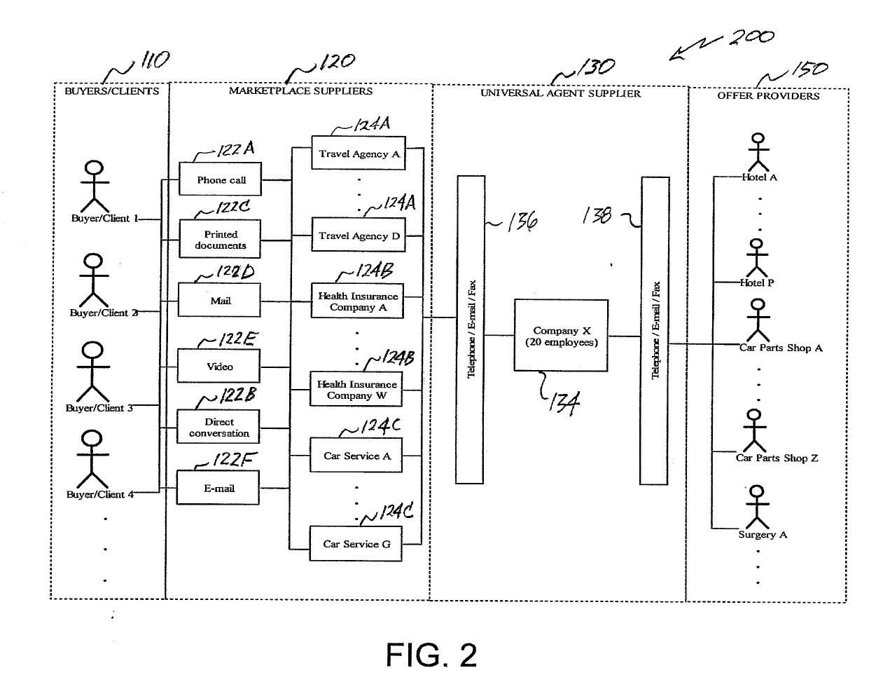

Another embodiment of the B2M transaction standard is shown on FIG. 2. It is an example of a B2M transaction standard business environment 200 where the marketplace(s) 124 and the universal agent 134 are implemented in analog form. Marketplaces 124 may, for example, take the form of one or more travel agencies 124A, one or more health insurance companies 124B and one or more car services 124C. The universal agent 134 is implemented as, for example, a company employing twenty people. The B2M transaction standard business environment 200 is not limited to the forms and number of the illustrated analog marketplaces 124A-124C within FIG. 2, and in other embodiments the analog marketplaces 124 may take other forms in addition to or in place of the illustrated travel agencies 124A, health insurance companies 124B and car services 124C. Likewise, the analog universal agent 134 is not limited to a company employing twenty people, and may, in general, be an individual or an organization of any type having any number of people.

In the present embodiment, there are six types of media 122 for communication between customers 110 and the marketplaces 124A-124C. The media 122 include two-way media 122 such as: telephone 122A and direct conversation 122B, and one-way media 122 such as: printed documents 122C, mail 122D, video 122E and e-mail 122F. The B2M transaction standard business environment 200 is not limited to the types and number of the illustrated media 122A-124F within FIG. 2, and in other embodiments the media 122 may take other forms in addition to or in place of the illustrated telephone 122A, direct conversation 122B, printed documents 122C, mail 122D, video 122E and e-mail 122F media 122.

The marketplaces 124A-124C and the universal agent 134 communicate by means of various media 136 such as, for example, telephone, fax and e-mail. The universal agent 134 and the offer providers 150 also communicate by means of various media 138 such as, for example, telephone, fax and e-mail. The type media 136 by which the marketplaces 124A-124C and the universal agent 134 communicate may be the same or different from the type of media 138 by which the offer providers 150 and the universal agent 134 communicate, and such media 136, 138 may be of various types in addition to or in place of one or more of the telephone, fax and email type media 136, 138.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A method for facilitating transactions of wares between customers and offer providers, said method comprising the steps of:
(a) conducting an offer construction process involving one or more offer providers and a universal agent supplier, wherein the one or more offer providers offer wares available for transaction with customers and wherein the universal agent supplier provides a universal agent to which offers of wares are communicated;
(b) conducting a marketplace construction process involving one or more marketplace suppliers and the universal agent supplier, wherein the one or more marketplace suppliers provide one or more marketplaces and one or more media for customer communication with the marketplaces and wherein wares available on said marketplaces are provided by said universal agent; and
(c) conducting a transaction process wherein a single universal agent operating separately from the one or more marketplaces processes transaction requests from customers relating to wares offered by the one or more offer providers on the one or more marketplaces and presented to the customers through the one or more media.

2. The method of claim 1 wherein said step of conducting an offer construction process comprises:
(i) defining one or more offers of wares available for transaction with customers, wherein the one or more offers are defined by the one or more offer providers and are included in one or more business domains;
(ii) creating delegations by the offer provider related to the one or more offers, wherein a delegation specifies whether the universal agent has authority on behalf of the offer provider to complete a transaction relating to an offer; and
(iii) placing the one or more offers and related delegations with the universal agent.

3. The method of claim 2 wherein said step of conducting a marketplace construction process comprises:
(i) establishing communication between the one or more marketplaces and the universal agent;
(ii) receiving information about business domains available to the universal agent;
(iii) selecting at least one business domain; and
(iv) providing information from the one or more marketplaces through the one or more media to customers about the offers available in the at least one business domain.

4. The method of claim 3 wherein said step of conducting a transaction process comprises:
(i) receiving at a marketplace a transaction request from a customer relating to an offer of wares defined by an offer provider;
(ii) transmitting the transaction request from the marketplace to the universal agent;
(iii) completing the transaction request at the universal agent when the universal agent is delegated authority by the offer provider to complete transactions relating to the offer of wares; and
(iv) informing the offer provider of the transaction request when the universal agent is not delegated authority by the offer provider to complete transactions relating to the offer of wares.

5. The method of claim 2 wherein said step of conducting a transaction process comprises:
(i) receiving at a marketplace a transaction request from a customer relating to an offer of wares defined by an offer provider;
(ii) transmitting the transaction request from the marketplace to the universal agent;
(iii) completing the transaction request at the universal agent when the universal agent is delegated authority by the offer provider to complete transactions relating to the offer of wares; and
(iv) informing the offer provider of the transaction request when the universal agent is not delegated authority by the offer provider to complete transactions relating to the offer of wares.

6. The method of claim 1 wherein said step of conducting a marketplace construction process comprises:
(i) establishing communication between the one or more marketplaces and the universal agent;
(ii) receiving information about business domains available to the universal agent;
(iii) selecting at least one business domain; and
(iv) providing information from the one or more marketplaces through the one or more media to customers about the offers available in the at least one business domain.

7. The method of claim 6 wherein said step of conducting a transaction process comprises:
(i) receiving at a marketplace a transaction request from a customer relating to an offer of wares defined by an offer provider;
(ii) transmitting the transaction request from the marketplace to the universal agent;
(iii) completing the transaction request at the universal agent when the universal agent is delegated authority by the offer provider to complete transactions relating to the offer of wares; and
(iv) informing the offer provider of the transaction request when the universal agent is not delegated authority by the offer provider to complete transactions relating to the offer of wares.

8. The method of claim 1 wherein said step of conducting a transaction process comprises:
(i) receiving at a marketplace a transaction request from a customer relating to an offer of wares defined by an offer provider;
(ii) transmitting the transaction request from the marketplace to the universal agent;
(iii) completing the transaction request at the universal agent when the universal agent is delegated authority by the offer provider to complete transactions relating to the offer of wares; and
(iv) informing the offer provider of the transaction request when the universal agent is not delegated authority by the offer provider to complete transactions relating to the offer of wares.

9. The method of claim 1 wherein an individual or entity acting as the universal agent supplier is separate from each individual or entity acting as a marketplace supplier.

10. The method of claim 1 wherein an individual or entity acting as the universal agent supplier is separate from each individual or entity acting as an offer provider.

11. The method of claim 1 wherein an individual or entity acting as the universal agent supplier is separate from each individual or entity acting as a customer.

12. A method for facilitating transactions of wares between customers and offer providers, said method comprising the steps of:
(a) conducting an offer construction process involving one or more offer providers and a universal agent supplier, wherein the one or more offer providers offer wares available for transaction with customers and wherein the universal agent supplier provides a universal agent to which offers of wares are communicated, said conducting an offer construction process including:
(i) defining one or more offers of wares available for transaction with customers, wherein the one or more offers are defined by the one or more offer providers and are included in one or more business domains;
(ii) creating delegations by the offer provider related to the one or more offers, wherein a delegation specifies whether the universal agent has authority on behalf of the offer provider to complete a transaction relating to an offer; and
(iii) placing the one or more offers and related delegations with the universal agent;
(b) conducting a marketplace construction process involving one or more marketplace suppliers and the universal agent supplier, wherein the one or more marketplace suppliers provide one or more marketplaces and one or more media for customer communication with the marketplaces and wherein wares available on said marketplaces are provided by said universal agent, said conducting a marketplace construction process including:
(i) establishing communication between the one or more marketplaces and the universal agent;
(ii) receiving information about business domains available to the universal agent;
(iii) selecting at least one business domain; and
(iv) providing information from the one or more marketplaces through the one or more media to customers about the offers available in the at least one business domain; and
(c) conducting a transaction process wherein a single universal agent operating separately from the one or more marketplaces processes transaction requests from customers relating to wares offered by the one or more offer providers on the one or more marketplaces and presented to the customers through the one or more media, said conducting a transaction process including:
(i) receiving at a marketplace a transaction request from a customer relating to an offer of wares defined by an offer provider;
(ii) transmitting the transaction request from the marketplace to the universal agent;
(iii) completing the transaction request at the universal agent when the universal agent is delegated authority by the offer provider to complete transactions relating to the offer of wares; and
(iv) informing the offer provider of the transaction request when the universal agent is not delegated authority by the offer provider to complete transactions relating to the offer of wares.

13. The method of claim 12 wherein an individual or entity acting as the universal agent supplier is separate from each individual or entity acting as a marketplace supplier.

14. The method of claim 12 wherein an individual or entity acting as the universal agent supplier is separate from each individual or entity acting as an offer provider.

15. The method of claim 12 wherein an individual or entity acting as the universal agent supplier is separate from each individual or entity acting as a customer.
